(19) United States
(12) Patent Application Publication
(10) Pub. No.: US 2010/0109505 A1
(43) Pub. Date: May 6, 2010

(54) Dielectric Barrier Discharge Lamp Configured as a Double Tube

(76) Inventors: Oliver Rosier, Wipperfurth (DE); Markus Roth, Bonn (DE); Reinhold Wittkotter, Wipperfurth (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/597,882

(22) PCT Filed: Apr. 27, 2007
(86) PCT No.: PCT/EP07/54158

§ 371 Date: Oct. 27, 2009

(51) Int. Cl. H01J 1/88

(52) U.S. Cl. 313/244

(57) ABSTRACT

A dielectric barrier discharge lamp comprising: a discharge vessel that comprises an outer tube and an inner tube, wherein the inner tube is arranged coaxially inside the outer tube, and wherein the inner tube and the outer tube are connected to one another in a gastight fashion, as a result of which a discharge space filled with a discharge medium is formed between the inner and outer tubes; and a first electrode and at least one further electrode, the first electrode being arranged inside the inner tube, wherein the first electrode is configured as a tube, the tube being provided with at least one slot that has a component locally or at least in some sections, both in an axial and in an azimuthal direction with respect to the longitudinal axis of the tube.

### TECHNICAL FIELD

The invention proceeds from a dielectric barrier discharge lamp having a discharge vessel in a coaxial double tube arrangement, that is to say an inner tube is arranged coaxially inside an outer tube. In this case, the inner tube and outer tube are connected to one another at their two end faces and thus form the gastight discharge vessel. The discharge space enclosed by the discharge vessel thus extends between the inner and outer tubes.

This type of discharge lamp typically has a first electrode that is arranged inside the inner tube, and a second electrode that is arranged on the outside of the outer tube. Both electrodes are therefore located outside the discharge vessel. What is involved in this case therefore is a discharge which is dielectrically impeded at two ends. When, for the sake of simplicity, there is occasional mention below of the internal electrode, or inner electrode, and of the external electrode, or outer electrode, this designation therefore relates solely to the spatial arrangement of the relevant electrode with regard to the coaxial double tube arrangement, that is to say inside the inner tube and, respectively, on the outside of the outer tube. On the one hand, the internal electrode is to bear tightly against the wall of the inner tube, that is to say without sagging, and on the other hand it is to be as easy to mount as possible.

This type of lamp is used in particular for UV irradiation in process engineering, for example for surface cleaning and surface activation, photolytics, ozone generation, drinking water purification, metallization, and UV curing. The designation of radiator or UV radiator is also common in this context.

### PRIOR ART

A coaxial double tube radiator is disclosed in the document DE 42 22 130 A1. The inner electrode is designed here as a helical metal wire. However, it is disadvantageous that this type of inner electrode makes contact with the inner tube only on a relatively small surface proportion. Moreover, corresponding to the helical metal wire is a relatively long conductor track with a correspondingly higher ohmic resistance and inductive impedance, the result being a worsening of the coupling of energy.

EP 0 703 603 A1 discloses a coaxial double tube radiator whose tubular inner electrode has a continuous straight slot in a longitudinal axial direction. As an alternative, a tubular inner electrode made from half shells mutually spaced apart is disclosed. However, it is disadvantageous that both fluctuations in diameter along the inner tube, and corrugations and other unevennesses in a circumferential direction cannot be compensated.

### SUMMARY OF THE INVENTION

It is the object of the present invention to specify a dielectric barrier discharge lamp in coaxial double tube arrangement having an improved internal electrode.

This object is achieved by means of a dielectric barrier discharge lamp having a discharge vessel that comprises an outer tube and an inner tube, the inner tube being arranged coaxially inside the outer tube, and the inner tube and the outer tube being connected to one another in a gastight fashion, as a result of which a discharge space filled with a discharge medium is formed between the inner and outer tubes, and also having a first electrode and at least one further electrode, the first electrode being arranged inside the inner tube, characterized in that the first electrode is designed as a tube, the tube being provided with at least one slot that has a component locally or at least in some sections, both in an axial and in an azimuthal direction with respect to the longitudinal axis of the tube.

Moreover, the object is also achieved by virtue of the fact that the tube is provided with two or more axial slots.

Particularly advantageous refinements are to be found in the dependent claims.

The main idea of the invention consists in the slotting of the tube provided for the inner electrode being distributed suitably over the circumference or the lateral surface of the tube and not, as in the prior art, being restricted to one straight axial slot. To this end, the tube is provided according to the invention with at least one slot that—when the lateral surface of the tube is considered in cylindrical coordinates—has a component locally or at least in some sections both in a direction of the longitudinal axis (axially) and in a direction of the azimuth (azimuthally). Owing to the azimuthal component, a better adaptation to local unevennesses of the inner tube is also attained in a circumferential direction. The result of this is that better contact is achieved between the tubular inner electrode and the inner tube of the discharge vessel of the lamp in conjunction with improved mechanical stability.

In the case of a single slot, the latter is preferably continuous. In the case of a plurality of slots, at most one is continuous and the other slots are not, so that the tubular inner electrode does not decompose into a plurality of individual parts, something which would render handling virtually impossible.

In a first embodiment, the slot is helical. In other words, the slot turns helically about the longitudinal axis of the tubular inner electrode. Owing to the slot, which in accordance with the straight invention is lengthened by comparison with the straight slotting of the prior art, the inner electrode can be more effectively deformed locally and adapt to the unevennesses and corrugations of the inner tube. Moreover, an electric field that is more homogeneous is generated by the helical slot as compared with a straight slot. Consequently, and in conjunction with the improved contact between inner electrode and inner tube, a better coupling of energy into the discharge space is achieved and finally, there is an increase in the radiation efficiency. The preferred number of turns depends in this case on the length of the electrodes, the wall thickness of the tube used for the inner electrode, and on the tube diameter. It has proved to be advantageous when the number of turns lies between 1·l·d and 100·l·d, preferably between 5·l·d and 50·l·d, l denoting the length of the inner electrode in meters (m), and d denoting the wall thickness of the inner electrode in millimeters (mm). Specifically, it has emerged that the tubular nature of the inner electrode must be retained. Specifically, should the inner electrode be designed as a helical strip, this has disadvantage that in some circumstances it does not bear completely over the entire length of the inner tube but, after becoming unstressed in the inner tube when mounted, is applied only to individual sites, chiefly at the front and rear ends, of the inner tube.

In variants of the embodiment explained above, the slot is triangular, rectangular or U-shaped, or of meandering shape, in particular sinusoidal shape or serpentine shape.

In a further preferred embodiment, the tubular inner electrode has two or more not completely continuous slots. The slots preferably mutually overlap. The length of the overlap in mm in this case lies preferably in the range between 0.2·R and 8·R, with particular preference in the range between 1·R and 4·d, R denoting the radius of the inner tube in mm. Owing to the discontinuous slotting, the inner electrode is more stable mechanically against external influences. This has advantages in the case of transporting the lamps, for example, when it is otherwise possible for the inner electrode to be displaced or even deformed. Moreover, it is easier to handle the inner electrode with a plurality of discontinuous slots, for example when producing the lamps or when exchanging the inner electrode. Many different shapes are suitable for the slot in the case of this embodiment, for example including triangular, rectangular or U-shaped, meandering shape, in particular sinusoidal shape or serpentine shapes. Moreover, straight slots are also suitable and can run both axially and in an inclined fashion. It has proved to be particularly suitable when longitudinal and transverse slots are connected to one another. It is preferred for the slots thus connected to run once about the tube circumference when considered over the entire length. A yet more flexible adaptation of the inner electrode is achieved in this way even to small unevennesses of the inner tube.

The tubular inner electrode can be fabricated from a metal sheet, for example. In a preferred development, the metal sheet is perforated. Suitable, inter alia, as perforation patterns are round holes, but also rectangles, diamonds etc. The result of this by comparison with the unperforated designs and given the same wall thickness is a greater flexibility of the inner electrode. Consequently, the inner electrode becomes better adapted to the inner tube even for unevennesses on a very small scale. A further advantage of the perforated inner electrode is that it increases the dissipation of heat from the inner tube of the discharge vessel. This leads, finally, to a longer service life of the lamp. The unperforated surface fraction with reference to the overall surface of the inner electrode is typically between 0.1 and 0.95, preferably between 0.3 and 0.7.

The maximum clear span of the perforation preferably lies between 1 and 10 mm, since otherwise local field distortions result that reduce the radiation efficiency.

### BRIEF DESCRIPTION OF THE DRAWINGS

The aim below is to explain the invention in more detail with the aid of exemplary embodiments. In the figures:

FIG. 1a shows a longitudinal sectional illustration of an inventive dielectric barrier discharge lamp,

FIG. 1b shows a cross-sectional illustration of the lamp from FIG. 1,

FIG. 2 shows a side view of the inner tube including inner electrode of the lamp from FIG. 1,

FIG. 3 shows a side view of the inner tube including inner electrode of a variant with a continuous slot,

FIGS. 4 and 5 show further variants of an inner electrode with a continuous slot, in side view,

FIG. 6 shows a side view of the inner tube including inner electrode with discontinuous slots,

FIGS. 7 to 11 show a number of variants of an inner electrode with discontinuous slots, in side view.

### PREFERRED DESIGN OF THE INVENTION

Identical or functionally identical elements are provided in the figures with identical reference numerals.

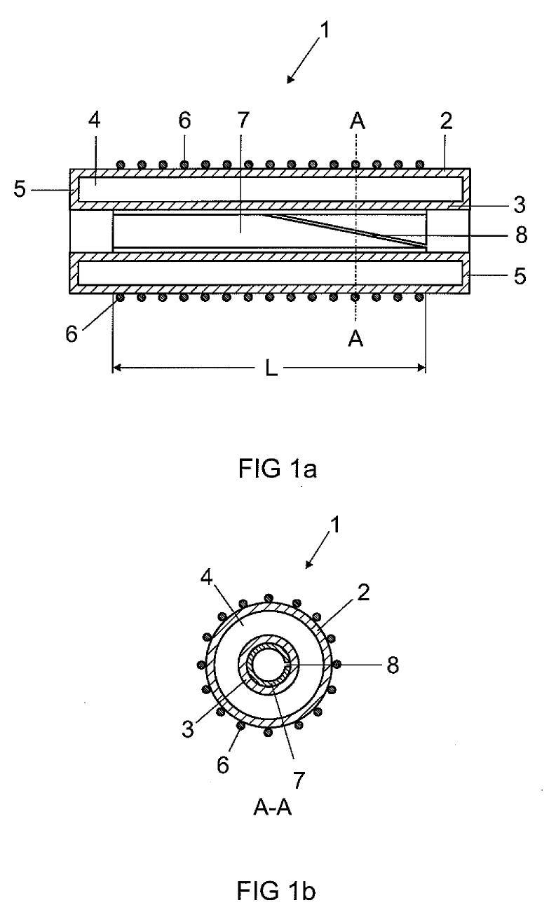

FIGS. 1a, 1b show in a highly schematic illustration a side view and a cross-sectional illustration of a first exemplary embodiment of the inventive dielectric barrier discharge lamp 1. The oblong discharge vessel of the lamp 1 comprises an outer tube 2 and an inner tube 3 in a coaxial double tube arrangement, which thus define the longitudinal axis of the discharge vessel. The typical length of the tubes is between approximately 10 and 250 cm, depending on the application. The outer tube 2 has a diameter of 40 mm and a wall thickness of 2 mm. The inner tube 3 has a diameter of 16 mm and a wall thickness of 1 mm. Both tubes 2, 3 consist of silica glass transparent to UV radiation. Moreover, the discharge vessel is sealed at both its end faces in such a way as to form an oblong discharge space 4 in the shape of an annular gap. To this end, the discharge vessel has at both its ends respectively suitably shaped, annular vessel sections 5. Moreover, applied to one of the vessel sections 5 is an exhaust tube (not illustrated) with the aid of which the discharge space 4 is first evacuated and subsequently filled with 15 kPa of xenon. Pulled onto the outside of the wall of the outer tube 2 is a wire grid 6 that forms the outer electrode of the lamp 1. Arranged in the interior of the inner tube 3, that is to say likewise outside the discharge space 4 enclosed by the discharge vessel, is a slotted metal tube 7 that forms the inner electrode of the lamp. The inner electrode 7 consists of a 0.1 mm thick metal sheet, preferably VA sheet. The slot 8 turns along the length L of the inner electrode 7—the latter being 0.5 m, here—about one turn, that is to say 360°. In the longitudinal sectional illustration of FIG. 1a, the cut is therefore to be detected only over half the length of a half shell of the longitudinally cut metal tube 7.

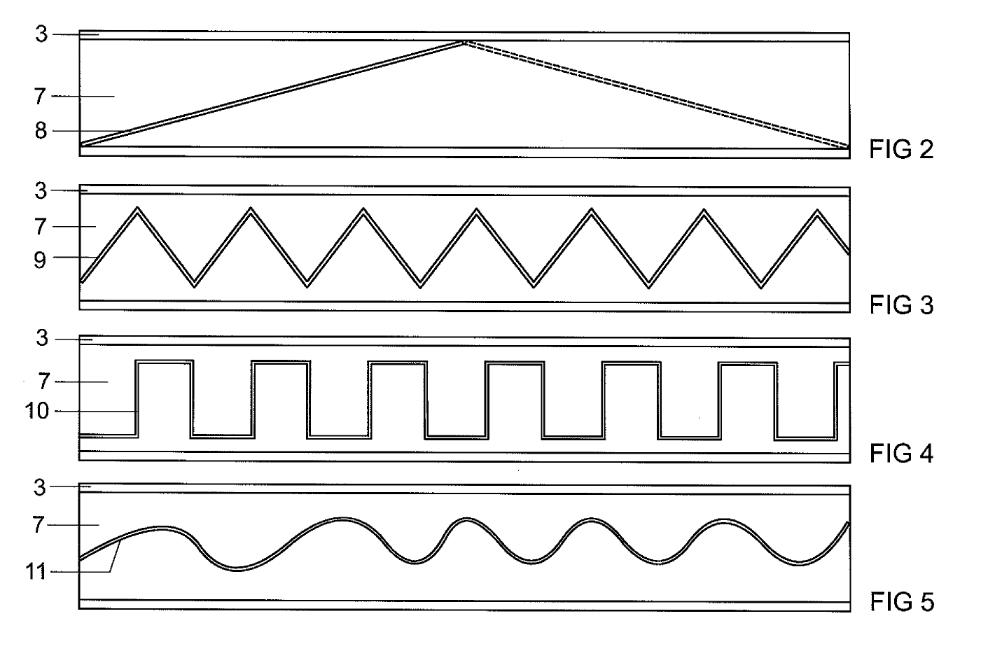

Reference is made below to FIG. 2, which shows the inner tube 3 including inner electrode 7, in a schematic side view. The outer tube with outer electrode is not illustrated here, for the purpose of greater clarity. Clearly to be seen in this illustration is the continuous slot 8 that turns fundamentally helically about the longitudinal axis of the tubular inner electrode 7, but here only with a single turn with respect to the entire length L of the inner electrode 7. What is decisive here is that the slot 8 is longer than a straight slot that runs parallel to the longitudinal axis of the inner electrode. Consequently, the inner electrode 7 can be deformed locally more effectively, and thus adapt to the inner wall of the inner tube 3, even in the case of typical local unevennesses of quartz tubes. However, the helical slot 8 produces an electric field which is more homogeneous as compared with a straight slot. Consequently, with the improved contact being made between inner electrode 7 and inner tube 3 a better coupling of energy is achieved into the discharge space 4 (see FIG. 1a) and, finally, an increase in the radiation efficiency is achieved.

FIGS. 3 to 5 show further variants of a slotted inner electrode 7 in the case of which the slot is respectively continuous as in FIG. 2. In detail, FIGS. 3 to 5 show a zigzag slot 9, a rectangular slot 10 and, finally, a serpentine slot 11.

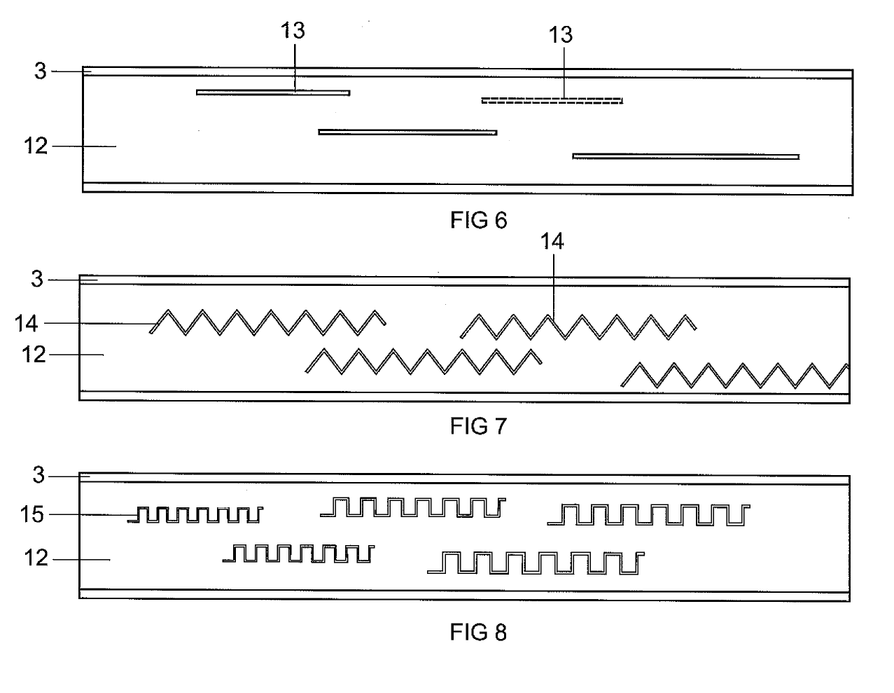

FIGS. 6 to 11 show a number of variants of an inner electrode having a plurality of discontinuous slots. Owing to the discontinuous slotting, the inner electrode 12 is more stable mechanically against external influences. This has advantages, for example in the case of transporting the lamps, where otherwise displacement, or even deformation of the inner electrode can occur. Moreover, the handling of the inner electrode 12 is easier, for example when producing the lamps or when exchanging the inner electrode 12.

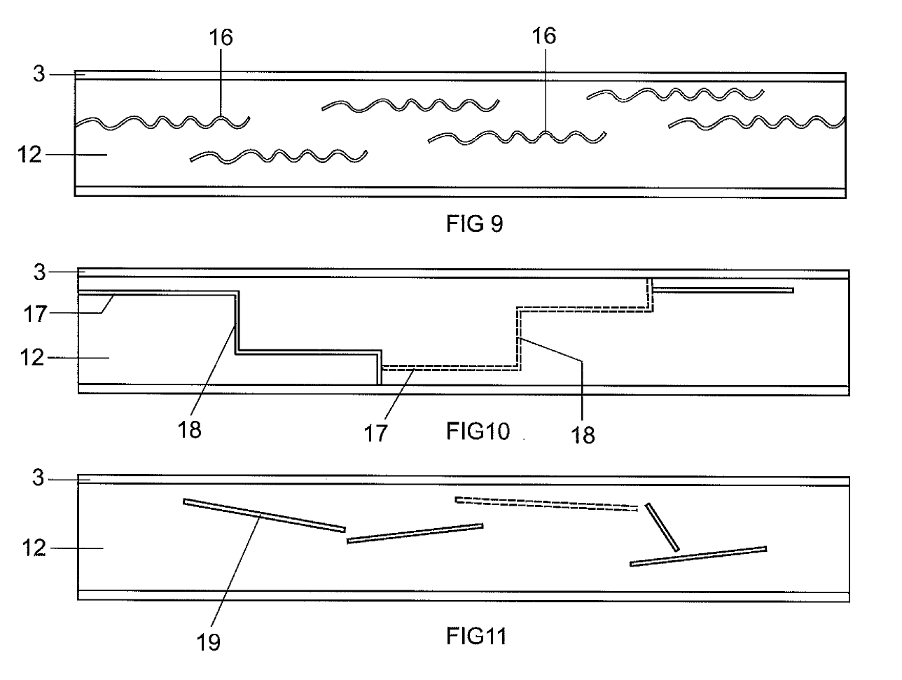

In FIGS. 6 to 9, the slots are arranged parallel to the longitudinal axis of the inner electrode 12 and in a fashion overlapping when viewed in the direction of the longitudinal axis. In detail, FIGS. 6 to 9 show straight slots 13, zigzag slots 14, rectangular slots 15 and, finally, serpentine slots 16. The individual slots are, however, arranged either along the entire longitudinal extent of the inner electrode 12 (FIG. 9), or at least the majority of the longitudinal extent (FIGS. 6, 7 and 8). Moreover, the slots are preferably arranged distributed over the entire circumference of the inner electrode 12.

A plurality of longitudinal slots 17 are connected by means of transverse slots 18 in FIG. 10. Consequently, a yet more flexible adaptation of the inner electrode to small unevennesses of the inner tube is achieved. In FIG. 11, a plurality of straight slots 19 are arranged in a fashion inclined, that is to say not parallel, to the longitudinal axis of the inner electrode 12.

In variants of the designs shown in FIGS. 2 to 11 that are not illustrated the inner electrode is respectively perforated. Suitable, inter alia, as perforation patterns are round holes, but also rectangles, diamonds etc. By comparison with the unperforated designs, this results in a higher flexibility of the inner electrode in conjunction with the same wall thickness. Consequently, the inner electrode becomes better adapted to the inner tube in particular for unevennesses on a very small scale.

1. A dielectric barrier discharge lamp comprising: a discharge vessel that comprises an outer tube and an inner tube, wherein the inner tube is arranged coaxially inside the outer tube, and wherein the inner tube and the outer tube are connected to one another in a gastight fashion, as a result of which a discharge space filled with a discharge medium is formed between the inner and outer tubes; and
a first electrode and at least one further electrode, the first electrode being arranged inside the inner tube,
wherein the first electrode is configured as a tube, the tube being provided with at least one slot that has a component locally or at least in some sections, both in an axial and in an azimuthal direction with respect to the longitudinal axis of the tube.

2. The lamp as claimed in claim 1, wherein the slot extends over the entire length of the electrode tube.

3. The lamp as claimed in claim 1 wherein the slot is helical.

4. The lamp as claimed in claim 3, wherein the number of helical turns of the slot lies between 1·l·d and 100·l·d, preferably between 5·l·d and 50·l·d, l denoting the length of the inner electrode in meters, and d denoting the wall thickness of the inner electrode in millimeters (mm)

5. The lamp as claimed in claim 1, wherein the slot is triangular.

6. The lamp as claimed in claim 1, wherein which the slot is rectangular or U-shaped.

7. The lamp as claimed in claim 1, wherein the slot is of meandering shape.

8. The lamp as claimed in claim 1, wherein the electrode tube has a plurality of slots that are arranged along the electrode tube.

9. The lamp as claimed in claim 8, wherein at least a portion of the slots mutually overlap, and the length of the overlap in this case lies preferably in the range between 0.2·R and 8·R, with particular preference in the range between 1·R and 4·R, R denoting the radius of the inner tube in mm.

10. The lamp as claimed in claim 8, at least some of the slots are arranged at different sites on the circumference of the electrode tube.

11. The lamp as claimed in claim 7, wherein the slots are rectilinear.

12. The lamp as claimed in claim 7, wherein the slots are triangular.

13. The lamp as claimed in claim 7, wherein the slots are rectangular or U-shaped.

14. The lamp as claimed in claim 7, wherein the slots are of meandering shape, in particular sinusoidal shape or serpentine shape.

15. The lamp as claimed in claim 7, wherein are arranged parallel to the longitudinal axis of the discharge tube.

16. The lamp as claimed in claim 7, wherein the slots are arranged in a fashion inclined to the longitudinal axis of the discharge tube.

17. The lamp as claimed in claim 9, wherein a portion of the slots are arranged parallel to the longitudinal axis of the discharge tube, and in which these longitudinal slots are connected to one another by means of transverse slots.

18. A dielectric barrier discharge lamp comprising:
discharge vessel that comprises an outer tube and an inner tube, the inner tube being arranged coaxially inside the outer tube, and the inner tube and the outer tube being connected to one another in a gastight fashion, as a result of which a discharge space filled with a discharge medium is formed between the inner and outer tubes; and
a first electrode and at least one further electrode, the first electrode being arranged inside the inner tube, wherein the first electrode is configured as a tube, the tube being provided with two or more axial slots.

19. The lamp as claimed in claim 18, wherein the first electrode is fabricated from sheet metal.

20. The lamp as claimed in claim 19, having a perforation.

21. The lam as claimed in claim 7, wherein the meandering shape is sinusoidal or serpentine.
